(19) United States
(12) Patent Application Publication
(10) Pub. No.: US 2018/0072205 A1
(43) Pub. Date: Mar. 15, 2018

(54) Ventilated Child Car Seat

(71) Applicant: Tomas Joel Suarez, Pflugerville, TN (US)

(72) Inventor: Tomas Joel Suarez, Pflugerville, TN (US)

(21) Appl. No.: 15/265,888

(22) Filed: Sep. 15, 2016

(51) Int. Cl. B60N 2/56; B60N 2/28

(52) U.S. Cl. CPC B60N 2/5642; B60N 2/28

(57) ABSTRACT

The current invention is a new ventilated child seat allows for the microenvironment of the infant seat to have better temperature control. The main components are: a car seat with a plurality of fans that are positioned in the bottom side of the car seat in the support structure, a control unit for the fans to control the fans speeds and turning them off and on, and angled covers over seatbelt holes that direct the air to the child to cool them down.

### CROSS-REFERENCES TO RELATED APPLICATIONS (IF ANY)

None.

### BACKGROUND

### 1. Field of the Invention

This invention relates to a child car seat and particularly, to one that proves ventilation to the child.

### 2. Description of Prior Art

Child seats are not only a requirement by state laws, they are simply vital for the protection of an infant or a young child. Since the early days of the seat's introduction and when they became a requirement over 30 years ago, child seats have evolved into “one stop” carriers for infants.

Today the seats and carriers are durable and build for safety and comfort. However, there is the one issue that does remain concerning comfort; the back of the child's back area cannot breath. The child may become overheated at worst and at best cranky from sweat and heat. This condition can even take place while the child is in an air-conditioned car. The problem is that most trips with infants are short and the A/C does not have enough time to help cool a child off that has been removed from a car and placed in the environment where temperatures are much hotter.

There is still room for improvement in the art.

### SUMMARY OF THE INVENTION

The current invention is a new ventilated child seat allows for the microenvironment of the infant seat to have better temperature control. The child then can be taken into and out of the car multiple times, without being disturbed by the heat differential on each trip. Additionally, some children sleep very comfortably in their seats, if a child is sound asleep in the seat when the parent arrives at their home, the parent can feel comfortable that they can leave the child in the seat.

The main components are: a car seat with a plurality of fans that are positioned in the bottom side of the car seat in the support structure, a control unit for the fans to control the fans speeds and turning them off and on, and angled covers over slots in the back of the car seat that direct the air to the child to cool them down.

The invention is more efficient and functional than the current air.

### BRIEF DESCRIPTION OF THE DRAWINGS

Without restricting the full scope of this invention, the preferred form of this invention is illustrated in the following drawings:

FIG. 1 is a side view of the preferred embodiment;

FIG. 2 is a back view of the embodiment;

FIG. 3 is front side view of the preferred embodiment;

FIG. 4 is a schematic of the electrical components and

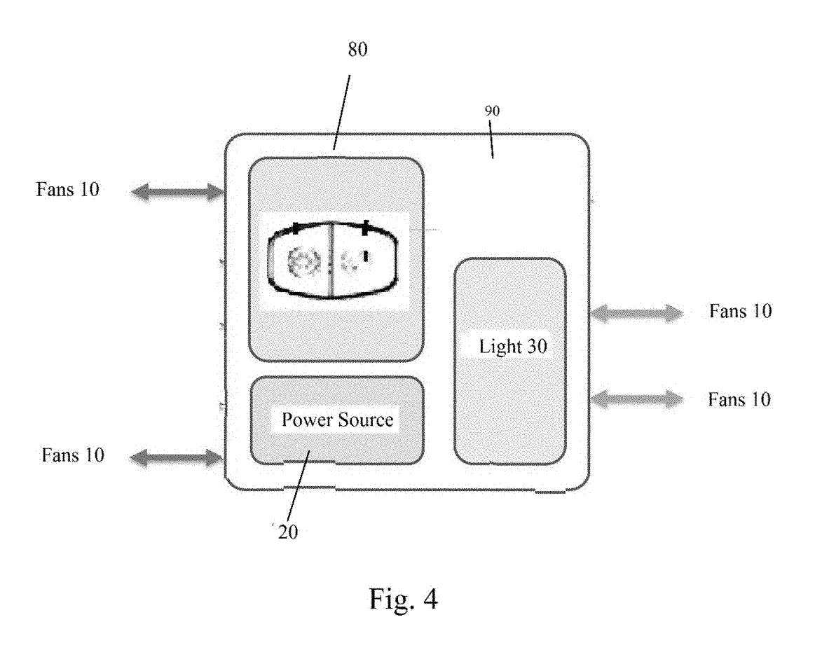

FIG. 5 shows the airflow through the cart seat.

### DESCRIPTION OF THE PREFERRED EMBODIMENT

There are a number of significant design features and improvements incorporated within the invention.

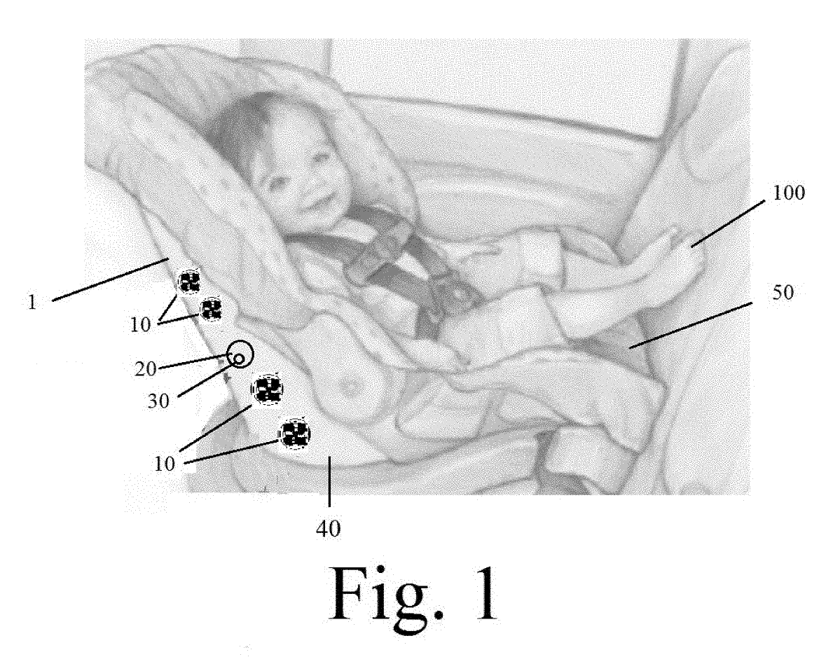

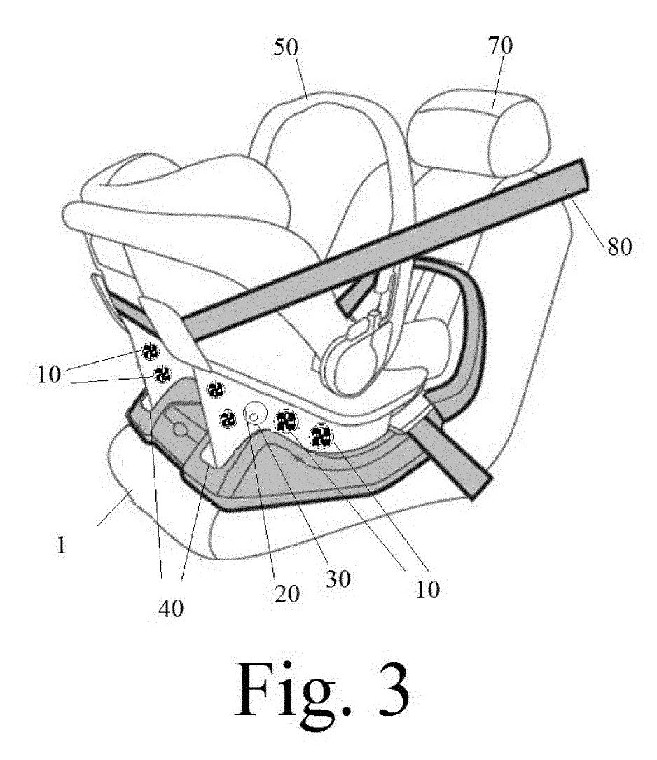

The current invention is a new ventilated child seat as shown in FIGS. 1-3.

The current invention allows for the microenvironment of the infant seat to have better temperature control. This allows the child 100 to be taken into and out of the car multiple times, without being disturbed by the heat differential on each trip.

The main components are: a car seat 50 with a plurality of fans 10 that are positioned in the sides 40 of the car seat in the support structure, a control unit 80 for the fans 10 to control the fans speeds and turning them off and on, and angled covers 60 over slots in the back of the car seat 50 which could be the seatbelt holes that direct the air to the child to cool them down. The fans 10 are each side are symmetrical to each other to provide equal air flow from each side.

To get the proper air flow in the car seat 50, there are a plurality of holes cut out on lower back area of car seat frame 40. In the preferred embodiment, all of the holes will have a ¼″ cover slant to capture the air. In these holes, fans 10 are placed. The fans 10 are faced so that the air is forced into the frame of the car seat 50 from outside the car seat 50.

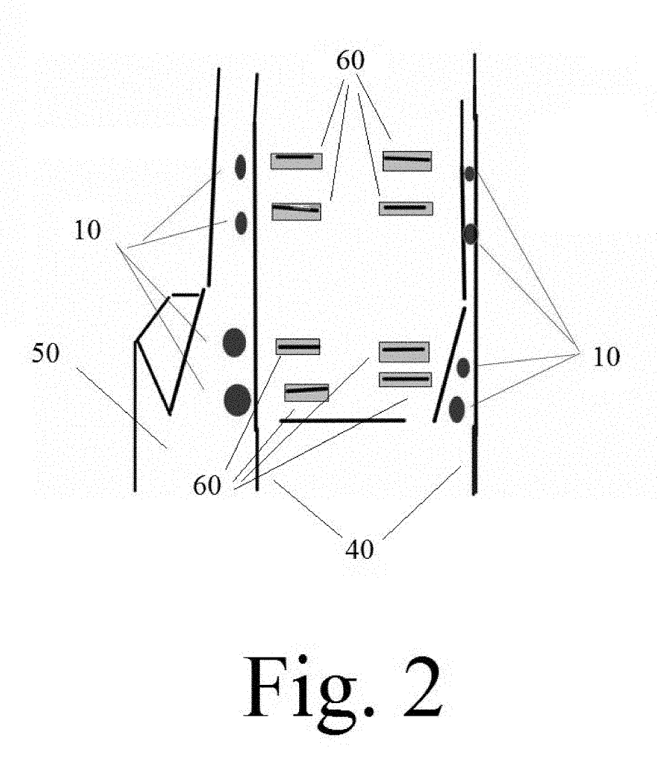

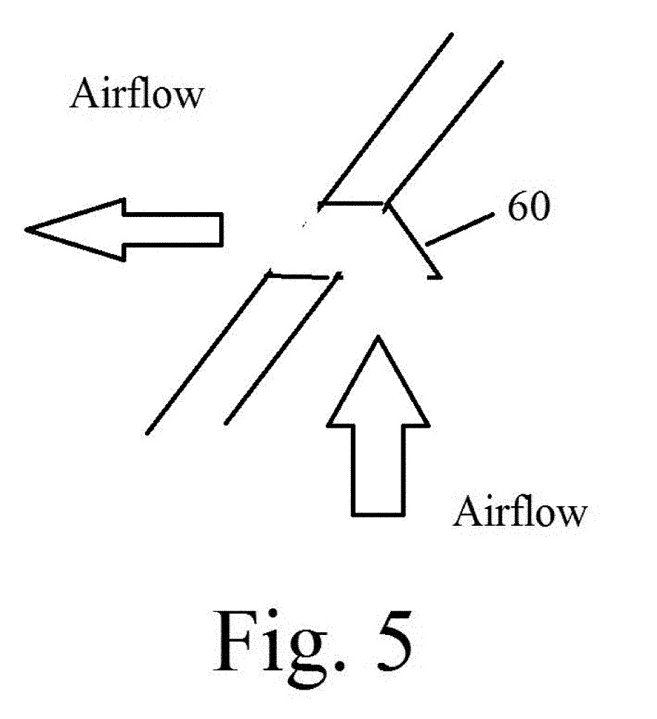

As shown in FIG. 2, the back of the child seat 50 has angled covers 60 over slots in the back of the car seat 50 to catch and vent the air to the child's back. ¼′ angled covers are used in the preferred embodiment. The seat belt holes can be used where the angle covers 60 are placed over the seat belt holes where the seat belt for the child goes. Both the seat belt holds and other openings with the angle covers 60 cam be used to provide the proper air flow. The airflow through the angle covers 60 is shown in FIG. 5.

In the preferred embodiment, the power source 20 is a set of batteries but can be any standard power source such as a USB cable. The power source 20 is connected to the power and control unit 80, the light 30 and the fans 10. It can be contained in a junction box 90 which connects the fans 10 the switch. The light 30 is a low battery light which will light red when the batteries are low. The power and control unit 80 will control the speed of the fans controlling the air flow as well as turning the fans on and off.

In the Figures a car seat 50 with an open back is shown. The current invention will work with a closed back as well. The invention can also be added to existing car seats 50.

### Advantages

The unique features of this product will provide the following benefits for consumers everywhere:

It will help prevent baby dehydration, rashes, frustration for the passengers and baby,

the ventilated material will let air flow through,
the small fans to direct air to baby's back, and
the control knob to adjust the fan pressure.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a car seat with a plurality of fans in the frame with a plurality of slots in the back.

2. A device according to claim 1 further comprising:
having angled covers coving said slots.

3. A device according to claim 2 further comprising:
having said angled covers direct air forward.

4. A device according to claim 1 further comprising:
having said fans direct air towards the inside of the frame.

5. A device according to claim 1 further comprising:
where the fans are placed symmetrically on the frame.

6. A device according to claim 1 further comprising:
having the fans connect to a control unit.

7. A device according to claim 6 further comprising:
having the control unit turn off and on the fans and control the speed of the fans.

8. A device according to claim 6 further comprising:
having a power source connect to the control unit.

9. A device according to claim 8 further comprising:
having a light connect to the control unit that shows when the power source is low.

10. A device comprising:
a car seat with a plurality of fans in the frame that direct the air towards the inside of the frame with a plurality of slots in the back, having angled covers coving said slots the direct air forward.

11. A device according to claim 10 further comprising:
where the fans are placed symmetrically on the frame.

12. A device according to claim 11 further comprising:
having the fans connect to a control unit which turns off and on the fans and controls the speed of the fans and connects to a power source.

13. A device according to claim 12 further comprising:
having a light connect to the control unit that shows when the power source is low.

14. A process comprising:
having a car seat;
placing a plurality of fans in the frame of said car seat that direct the air towards the inside of the frame;
having a plurality of slots in the back of said car seat;
covering the slots with angled covers that direct air forward.

15. A process according to claim 14 further comprising:
placing the fans symmetrically on the frame.

16. A process according to claim 14 further comprising:
having the fans connect to a control unit which turns off and on the fans and controls the speed of the fans and connects to a power source.

17. A device according to claim 16 further comprising:
having a light connect to the control unit that shows when the power source is low.
